(19) United States
(12) Patent Application Publication
(10) Pub. No.: US 2003/0126042 A1
(43) Pub. Date: Jul. 3, 2003

(54) On-line credit redemption system and method

(76) Inventors: Jeffrey B. Beegle, Eden Prairie, MN (US); Christopher C. Van Houtte, Waconia, MN (US); Andrew Thomas Althauser, Chanhassen, MN (US); Paul D. Constable, Maple Grove, MN (US); Richard Thomas Waldvogel, Longmont, CO (US)

Correspondence Address: FAEGRE & BENSON LLP, 2200 WELLS FARGO CENTER, 90 SOUTH 7TH STREET, MINNEAPOLIS, MN, 55402, US

(21) Appl. No.: 10/226,677

(22) Filed: Aug. 23, 2002

Related U.S. Application Data
(60) Provisional application No. 60/314,491, filed on Aug. 23, 2001.

(51) Int. Cl. G06F 17/60

(52) U.S. Cl. 705/27

(57) ABSTRACT

A system and method for on-line shopping are disclosed. The system and method allow one or more entities to sponsor on-line shopping programs that are individually tailored for each sponsor and at the same time provide a high degree of security flexibility and user flexibility. A programs sponsor can assign each user of the program an amount of credit, such as a performance-based reward. The sponsor can also select a set of vendors from whom the user can make purchases with the credit. The sponsor can establish conversion rates between the assigned credit and the currency used by the vendors if the credit is assigned in a unit (such as points) different from the currency unit (such as dollars). The user can then use the credit to shop at any of the vendors' on-line store while being reminded of the available credit displayed in the currency unit. After the user has selected the item(s) to purchase and confirmed the purchase, a credit card payment account individually established for the user is funded, and the funds are subsequently transferred to the vendor.

### CROSS REFERENCE TO RELATED APPLICATION

The present application claims priority to U.S. Provisional Application No. 60/314,491, filed Aug. 23, 2001. Said Provisional Application is incorporated herein by reference.3

### FIELD OF INVENTION

The invention relates generally to electronic purchases over computer networks. More particularly, the invention relates to a method and system for facilitating user access to a select set of vendor's on-line stores and user purchase of goods at the on-line stores at least partially with credit.

### BACKGROUND OF THE INVENTION

As the Internet becomes ever more widely accessible, on-line transactions are increasingly becoming a popular, and often preferred, mode of conducting business. As an example, a retailer may establish on-line stores, where shoppers can “browse” the store's merchandise by accessing the retailer's on-line documents such as web pages. In many instances, shoppers may also purchase desired merchandise and pay for their purchases by credit cards or debit cards. Such network-based virtual stores may drastically expand the reach of businesses.

Businesses are also making increasing use of the Internet to maintain or boost employee morale or customer loyalty by creating network-based incentive programs. According to one model for such programs, the program sponsor rewards qualified persons with money, such as cash or credit to the persons' credit card or bank accounts. With this model, qualified persons have a great amount of flexibility in using their rewards, but it is difficult for the sponsor to direct the use of the rewards in a way that advances the sponsor's more specific interests. For example, an employer sponsor may wish that qualified employees would use the reward money to purchase distinctive items so that the employee would be more likely to feel special due to the prestige of the items. But the employees may in fact use the money to purchase such things as common household items, grocery, or even worse, items repugnant to the employer's interests or values.

According to another model for such incentive programs, a sponsor may reward qualified persons points and, by itself or by contracting a third party, offer a collection of goods or services, each of which is worth a set number of points. With this model, a sponsor has the maximum control of the kinds of items a qualified person may obtain with his or her reward points. However, such an incentive program typically lacks flexibility if the number or variety of available award items is small, or is complex and costly to maintain if a substantial collection of reward items are offered. Additionally, because no currency amount is attached to a reward point, a qualified person may feel uncertain about the monetary value of the reward. As a result, the person may tend to feel that the reward is probably not worth what he or she deserves.

The Internet also offers opportunities for conveniently funding of on-line purchases. For example, for those who do not have credit or debit cards, there are services that allow people to fund a user's account and facilitate the user's purchases by providing a virtual credit card number to vendors on the user's behalf. At least some services of this type collect deposits for all users into one credit card account and use one credit card number for all user purchases. Such a method presents a high degree of security risk: an unauthorized access to the credit card number can result in the loss of funds for many, or even all, users.

The invention disclosed herein is aimed at improving on-line purchasing systems to provide each sponsor of an on-line purchasing program with individually tailored combination of user flexibility and sponsor control with a high degree of security.

### SUMMARY OF THE INVENTION

Generally, the invention provides a system and method whereby a sponsor of an on-line purchasing program can select a desired set of vendors from whom the participants (users) of the program can directly purchase merchandise at least partially with credit individually allotted to the participants.

According to one aspect of the invention, a method for implementing an online shopping program includes: (a) allocating an amount of credit, in a predetermined unit (such as points), available to a user; (b) providing the user with computer access (for example via the Internet) to a copy of at least a portion of a first on-line document (such as a web page) belonging to a vendor and containing a description and pricing information of at least one item from the first vendor for the user to purchase; (c) establishing a correspondence (such as a rate of conversion) between the predetermined unit of credit and a unit of a currency (such as dollar) in which the vendor's item is priced; (d) at least partially funding a payment account associated with the user with an amount corresponding to at least a portion of the allocated credit amount; (e) after the user confirms a purchase including the vendor's item, sending a sufficient payment from the payment account to the first vendor for the purchase; and (f) deducting the amount of credit available to the user by an amount corresponding to the purchase.

### BRIEF DESCRIPTION OF THE DRAWINGS

Other objects and advantages of the invention will become apparent upon reading the following detailed description and upon reference to the drawings in which:

FIG. 1 schematically shows a network environment in which an embodiment of the invention operates;

FIG. 2 outlines the main steps of the on-line shopping method according to an embodiment of the invention;

FIG. 3 illustrates a computer screenshot at the beginning of a shopping session in an example of user interface for the on-line shopping system and method according to an embodiment of the invention;

FIG. 4 illustrates a computer screenshot prompting the user to choose between using sponsor catalog and shopping directly at vendor web stores in a shopping session in an example of user interface for the on-line shopping system and method according to an embodiment of the invention;

FIG. 5 illustrates a computer screenshot showing shopping venues available to a user in a shopping session in an example of user interface for the on-line shopping system and method according to an embodiment of the invention;

FIG. 6 illustrates a computer screenshot showing a step in selecting merchandise at a vendor's web store in a shopping session in an example of user interface for the on-line shopping system and method according to an embodiment of the invention;

FIG. 7 illustrates a computer screenshot showing a step in selecting merchandise at a vendor's web store in a shopping session in an example of user interface for the on-line shopping system and method according to an embodiment of the invention;

FIG. 8 illustrates a computer screenshot showing a step in selecting merchandise at a vendor's web store in a shopping session in an example of user interface for the on-line shopping system and method according to an embodiment of the invention;

FIG. 9 illustrates a computer screenshot showing a step in selecting merchandise at a vendor's web store in a shopping session in an example of user interface for the on-line shopping system and method according to an embodiment of the invention;

FIG. 10 illustrates a computer screenshot showing a step in completing a purchase at a vendor's web store in a shopping session in an example of user interface for the on-line shopping system and method according to an embodiment of the invention;

FIG. 11 illustrates a computer screenshot showing a step in completing a purchase at a vendor's web store in a shopping session in an example of user interface for the on-line shopping system and method according to an embodiment of the invention;

FIG. 12 illustrates a computer screenshot showing a step in completing a purchase at a vendor's web store when a user's credit alone is insufficient for the purchase in a shopping session in an example of user interface for the on-line shopping system and method according to an embodiment of the invention;

FIG. 13 illustrates a computer screenshot showing a step in allowing a user to partially fund a purchase at a vendor's web store from other sources when the user's credit alone is insufficient for the purchase in a shopping session in an example of user interface for the on-line shopping system and method according to an embodiment of the invention;

FIG. 14 illustrates a computer screenshot showing a step in providing a vendor with the credit card information of a virtual credit card in a shopping session in an example of user interface for the on-line shopping system and method according to an embodiment of the invention;

FIG. 15 illustrates a computer screenshot prompting for billing address in a shopping session in an example of user interface for the on-line shopping system and method according to an embodiment of the invention;

FIG. 16 illustrates a computer screenshot prompting for shipping address in a shopping session in an example of user interface for the on-line shopping system and method according to an embodiment of the invention;

FIG. 17 illustrates a computer screenshot showing a summary of charges in a shopping session in an example of user interface for the on-line shopping system and method according to an embodiment of the invention;

FIG. 18 illustrates a computer screenshot showing a step in providing a vendor with the credit card information of a virtual credit card in a shopping session in an example of user interface for the on-line shopping system and method according to an embodiment of the invention;

FIG. 19 illustrates a computer screenshot showing a confirmation page with a re-calculated credit balance after the completion of a shopping session in an example of user interface for the on-line shopping system and method according to an embodiment of the invention;

FIG. 20 schematically illustrates the overall interaction among the various components of an on-line shopping system according to an embodiment of the invention; and

FIG. 21 schematically illustrates an on-line shopping system and interaction among certain components of the system according to an embodiment of the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Generally according to the invention, a system and method for on-line shopping allow one or more entities to sponsor on-line shopping programs that are individually tailored for each sponsor and at the same time provide a high degree of security flexibility and user flexibility.

In particular, a program sponsor can assign each user of the program an amount of credit, such as a performance-based reward. The sponsor can also select a set of vendors from whom the user can buy merchandise with the credit. The sponsor can establish conversion rates between the assigned credit and the currency used by the vendors if the credit is assigned in a unit (such as points) other than the currency unit (such as dollars). The user can then use the credit to shop at any of the vendors' on-line store while being reminded of the available credit displayed in the currency unit. After the user has selected the item(s) to purchase and confirmed the purchase, a credit card payment account individually established for the user is funded, and the funds are subsequently transferred to the vendor. The user's available credit is decreased by an amount that was converted to fund the payment account.

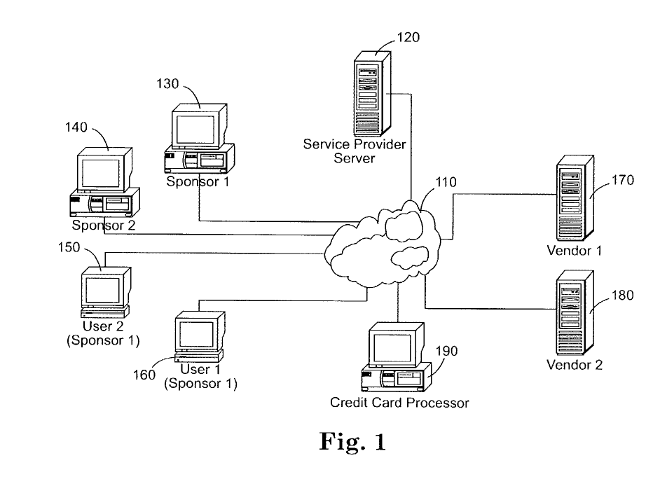

A system embodying the invention is schematically illustrated in FIG. 1. The system includes a server 120 for the Service Provider, who sets up and maintains on-line shopping programs for various sponsors. Each sponsor has its own computer system 130, 140, which communicates with the provider server 120 to exchange information on sponsored programs and their participants or users. Each program is available to its participants or users via computers, exemplified in FIG. 1 by “User 1” 160 and “User 2” 150 for program sponsored by Sponsor 1. Each program makes available to its users a set of vendors selected by the sponsor. The vendors operate on-line stores, represented by the vendor servers 170 and 180 in FIG. 1. The system also includes a credit card processor 190, which provides funds to pay the vendors for the users' purchases.

These components are networked together to form an on-line shopping system. In an illustrative embodiment, the components are operatively connected via a wide-area network 110 such as the Internet, but other well-known network configurations can also be used.

In an illustrative embodiment, the on-line shopping program is implemented by a method facilitated by software running on the Service Provider server 120. The software was written in C# (“C-Sharp” ) language in the Microsoft™.Net™ framework, but can be written in any suitable computer programming language as well.

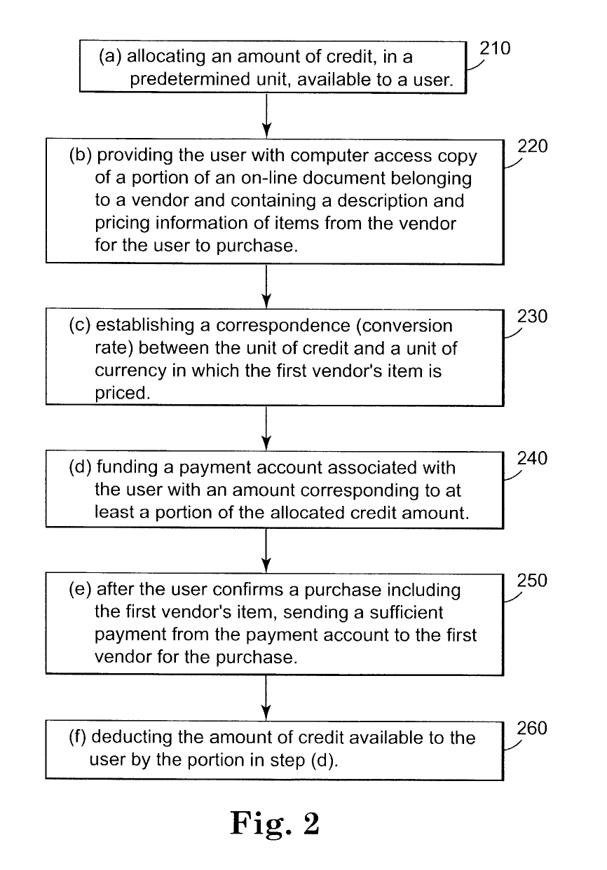

A method embodying the invention is outlined in FIG. 2. In the first step 210, the service provider allocates an amount of credit to a user of a program. The amount of credit can be determined based on a variety of factors. For example, in an employee incentive-based shopping program, the amount of credit can be based on the user's job performance. The credit can be measured in terms of any unit specified by the program sponsor. For example, the unit can be simply “point” or a currency units such as dollar.

The amount of credit allocated to a user can be dictated to the service provider by the sponsor via the sponsor computer system 130, 140 and the network 110, and in any suitable manner. For example, a sponsor can simply transmit to the service provider how many points a user should have to have added; alternatively, a sponsor can transmit to the service provider a set of parameters indicative of the a user's performance (for example, monthly sales, customers served, etc.), and the service provider will calculate the amount of credit based on a formula that the sponsor has determined.

In the next step 220, when a user reaches the service provider server 120 (by accessing a web page, for example) to redeem his or her credit for merchandise at one of the set of vendors selected by the sponsor, the server 120 obtains a copy of the vendor's web store web page from the vendor's server 170, 180.

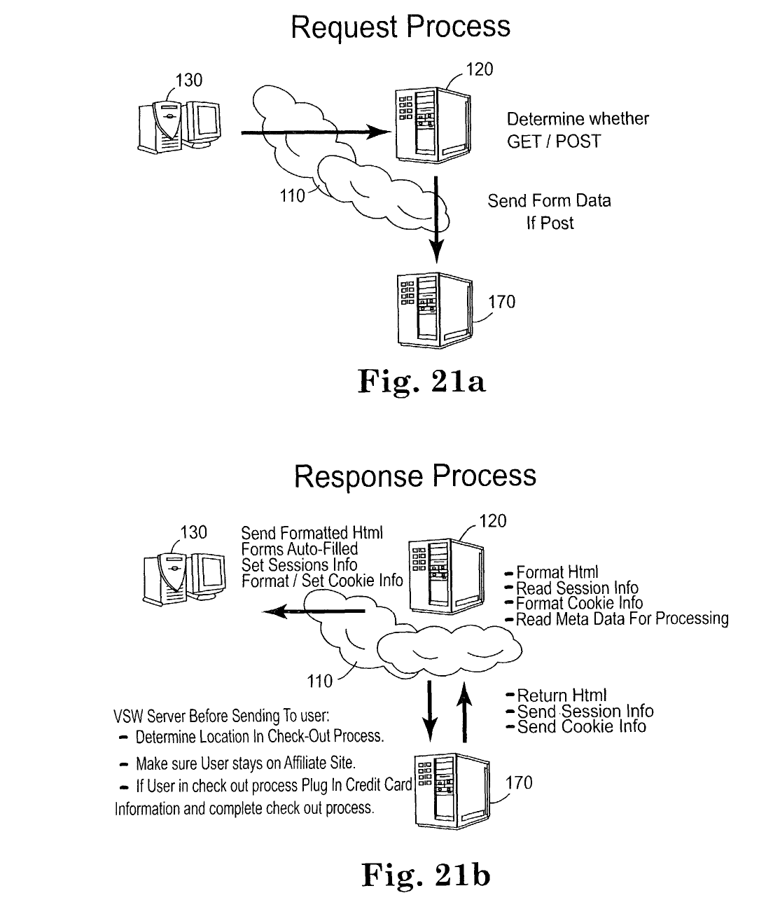

The process is schematically illustrated in more detail in FIG. 21. A user proceeds in a shopping session by sending a request to the service provider server 120 for a particular vendor. In response, the server 120 relays the request to the vendor's server 170 (FIG. 21(a)). The vendor server 170 responds by sending the provider server 120 the requested web page (for example, the page showing an item that the user selected in the previous page). Other auxiliary information, such as session information and cookie information, is also sent where appropriate. The provider server 120 then reformats the web page, if appropriate, reads any auxiliary information, reads and processes the meta-data and sends the reformatted page to the user when appropriate.

In reformatting the vendor web page, the provider server 120 can maintain the over-all look and feel of the web page while tailor the page to the sponsor's and user's interests. For example, the vendor web page can be combined with images and text showing the sponsor's logo and user information such as name and available credit.

Another function of reformatting is to provide sponsor control. For example, a vendor's web page may provide links to other on-line retailer's web stores that the users are not permitted to shop with their credit given by the sponsor. The vendor web page can be reformatted to disable those links or not display the links at all.

The provider server 120 can use the meta-data in the vendor web page for a variety of purposes. For example, by monitoring certain meta-tags, the service provider can become timely aware of changes of interest in the vender's web page and take appropriate actions.

Thus, by sending the user a copy of the vendor's web pages, rather than providing a direct link to those web pages, the service provider can offer not only most relevant content of the web pages but also sponsor- and user-specific information and a high degree of sponsor control.

Referring again to FIG. 2, the provider next (230) establishes a correspondence between the credit unit and the unit of currency used by the vendor if the unit of the two unit are not the same. The correspondence can be a simple conversion rate such as “dollars per point” or it can be any other defined relationship. Typically, a user's available credit amount is converted to a currency amount by the establishment of the correspondence. However, the prices of items carried by a vendor can also be converted to number of points.

The correspondence in the illustrative embodiment is defined by the program sponsor and dictated to the service provider, who then establishes the correspondence in the implementation of the program. The sponsor can also define different rules of correspondence for different vendors. For example, a point can be worth a dollar at one vendor's store but $1.50 at another. The sponsor can thus effectively choose to make one vendor more attractive than another depending on the sponsor's needs.

In the next step 240, the provider server 120 funds a payment account for later payment to the vendor for the user's purchase from the vendor. The payment account in an illustrative embodiment is a credit card account set up with a credit card processor 190. In the illustrative embodiment, each user is given a credit card account as the payment account and assigned a unique credit card account number, which the user does not know. This approach, as opposed to having the same credit card account number for multiple users, reduces the potential loss in the event that the credit card number is misappropriated. In addition, the funding is not effectuated until the user has confirmed a purchase. This feature further enhances security because the balance in the payment is maintained at zero or below a predetermined level so that even if the credit card number is misappropriated, there is no or only a small loss due to misuse.

The funding of the payment account can be limited to an amount corresponding to the user's total available credit. In an illustrative embodiment of the invention, if that amount is insufficient for the purchase the user desires, the provider server 120 initiates a process to let the user to supplement the amount with funds from another source, such as the user's personal credit card. The funds added by the user is then credited to the payment account.

After the user confirms the purchase, the vendor is paid from the payment account for the purchase (250). Typically, the credit card processor 190 transmits to the vendor the funds it receives from the service provider 120, but any suitable route of fund transfer can be used.

As the final step (260) in the illustrative embodiment, the provider server deducts the amount of the user's available credit by an amount corresponding to the amount funded to the payment account by the credit card processor.

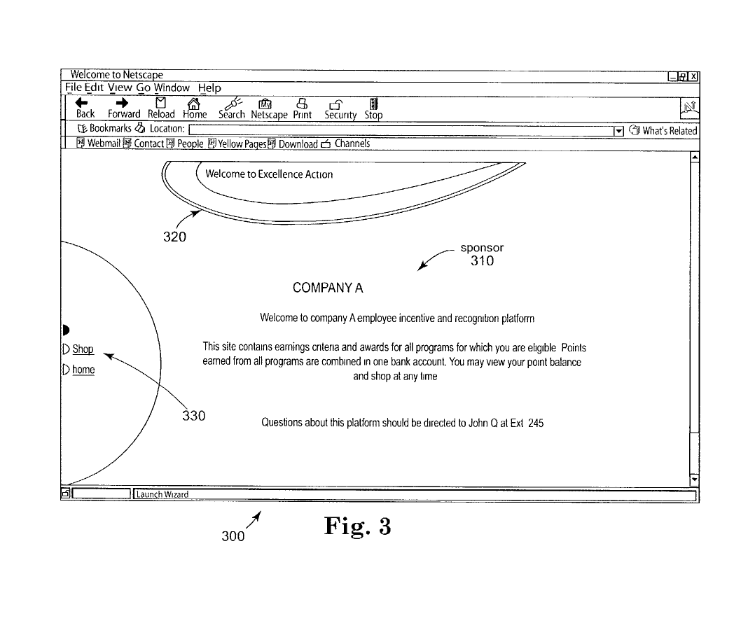

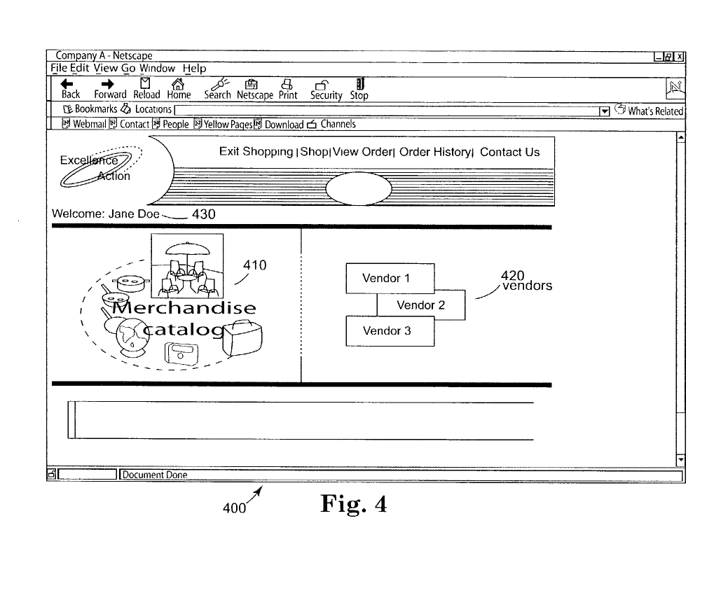

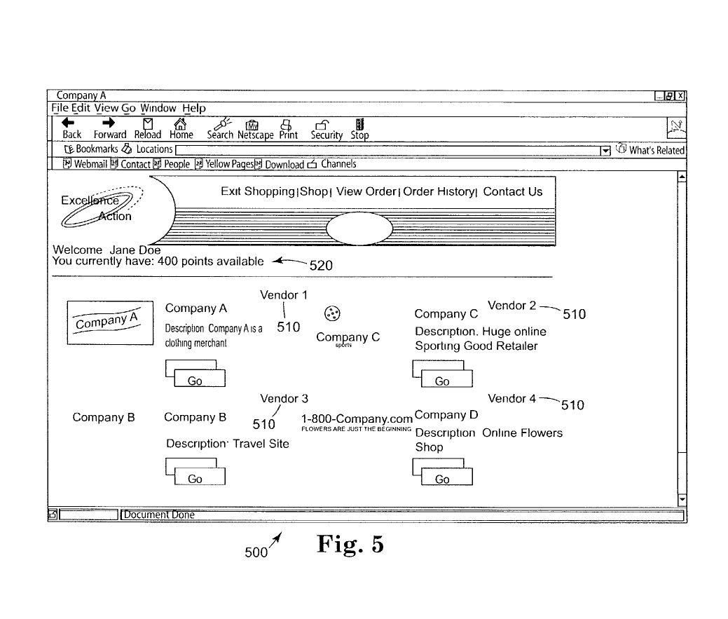

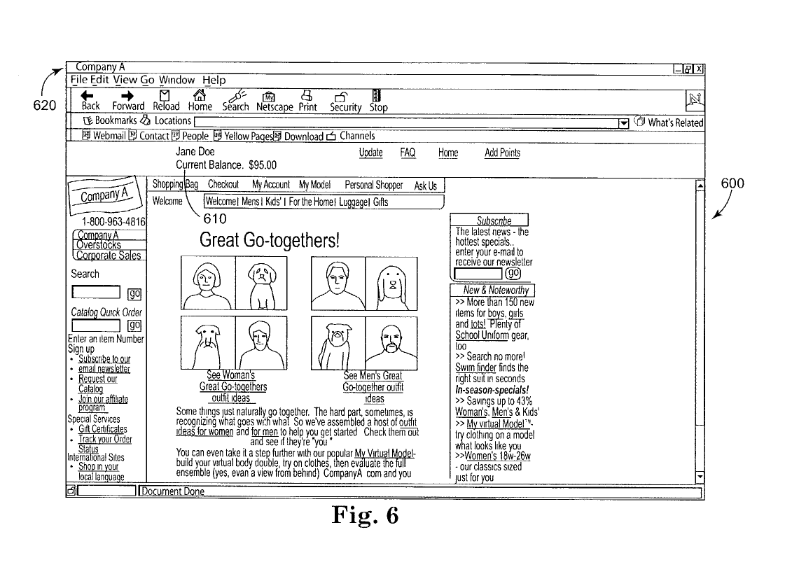

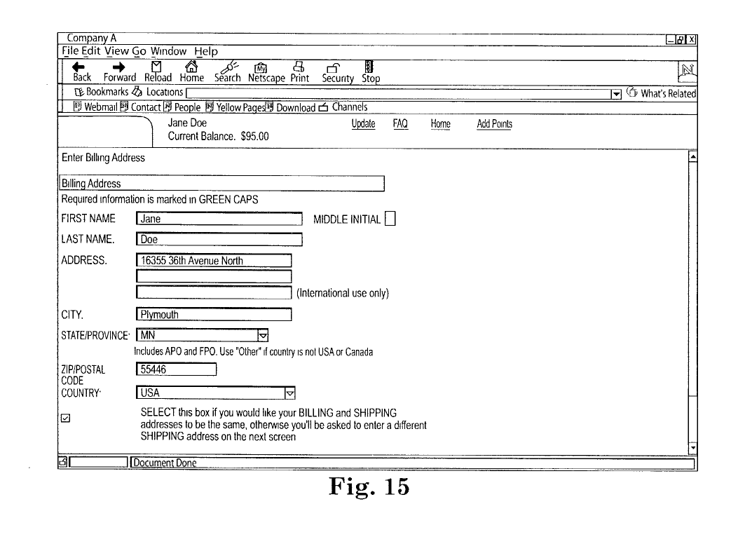

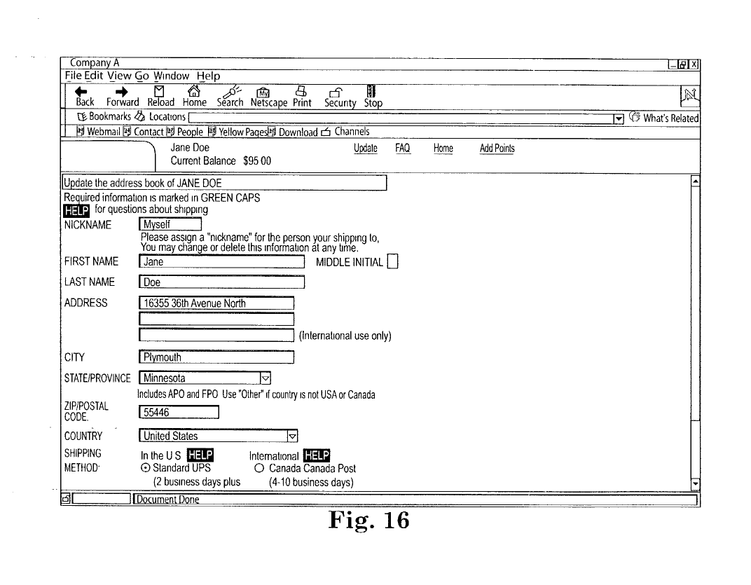

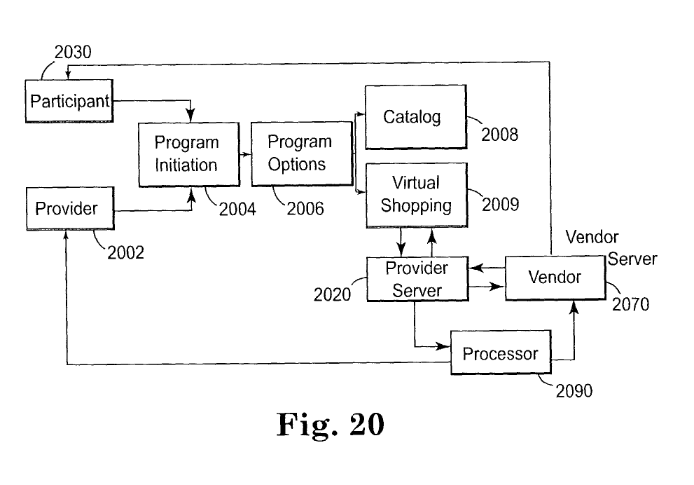

An example of an on-line shopping session according to one aspect of the invention is shown in FIGS. 3-20. When a user 2030 reaches the program's web page on the server of the service provider 2002, the user is presented with an introductory page 300, 2004, which displays, among other things, the sponsor information 310, program name 320 and an option 330 to initiate shopping. Once the user successfully goes through the authentication steps, the provider server displays the user's name 430 and provides the user with the choice 2006 of shopping from the sponsor's catalog 410, 2008 or directly from a sponsor defined set of vendors 420, 2009. If the user chooses the latter, the interactions among the user 2030, service provider 2002, the service provider server 2020, the vendor server(s) 2070 and credit card processor 2090 begins as described above.

The provider server first presents the user with a menu 500 from which to choose a vendor from the set of vendors 510. The display also shows the user the amount of his or her available credit as points (520). Upon the user choosing a vendor, a reformatted copy of the vendor's web page 600 is displayed. The user's available credit amount has been converted to, and is displayed in, dollars (610). The vendor's web pages are also displayed within a frame that identifies the sponsor (620).

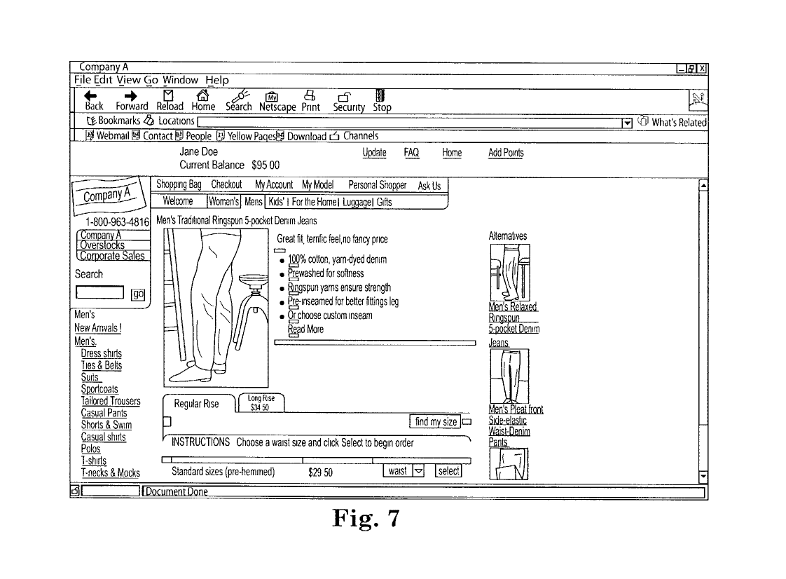

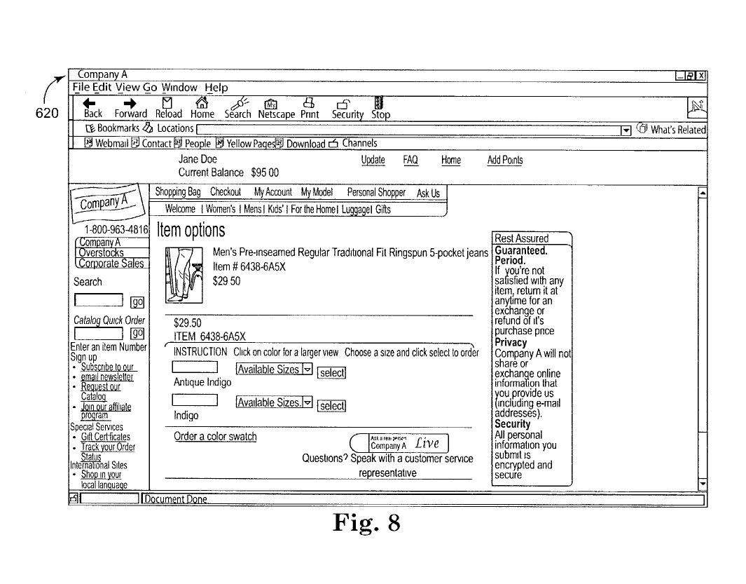

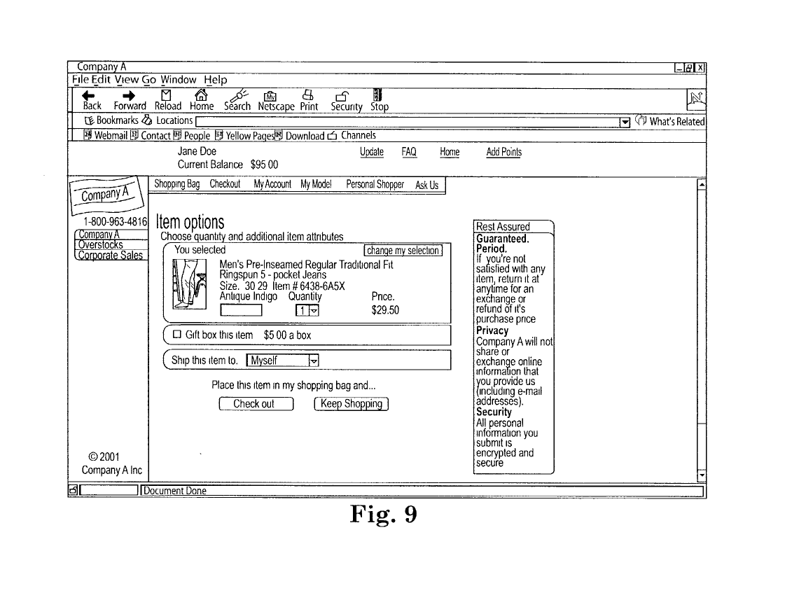

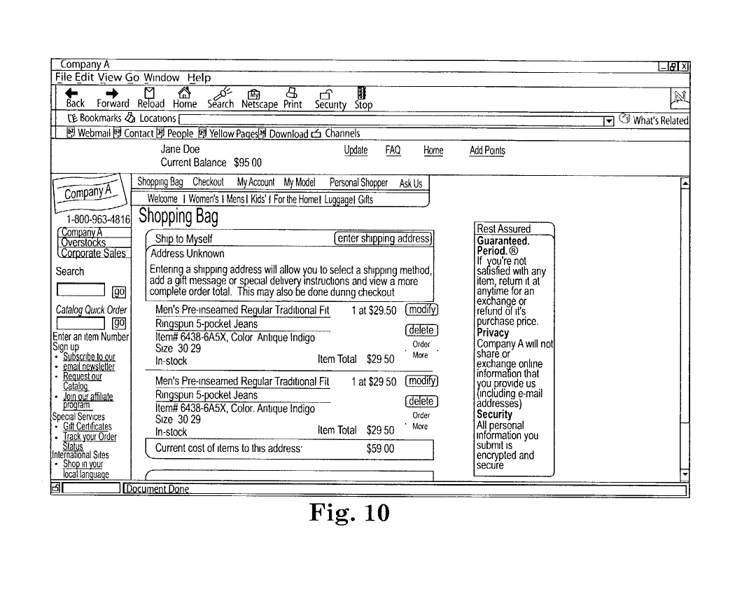

The user is now led through the steps designed by the vendor in selecting items, in this example of articles of clothing including browsing catalog and choosing items (not shown); selection of style and size (FIG. 7), color (FIG. 8), and quantity (FIG. 9); and reviewing a summary of selected items (FIG. 10).

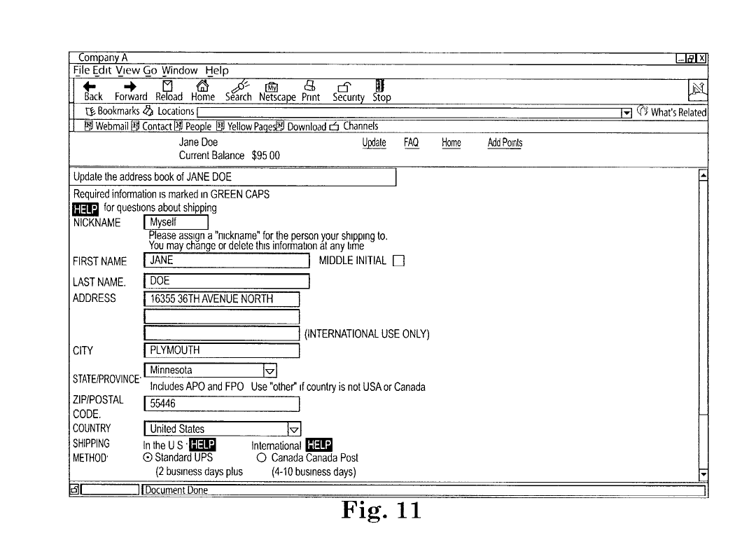

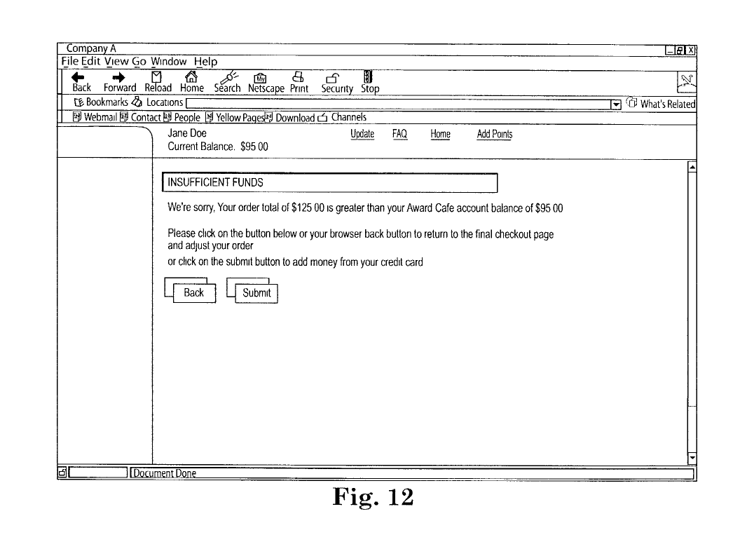

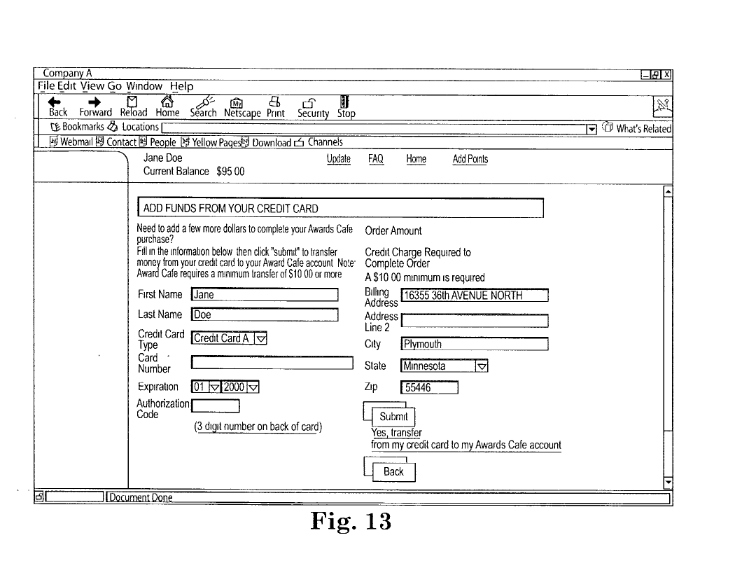

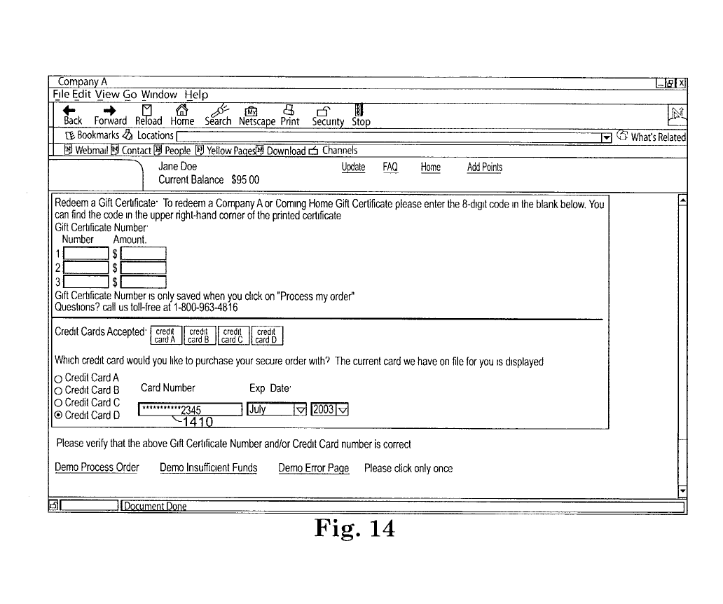

When the checkout page requesting credit card information and shipping information occurs, the provider server passes in the user's unique virtual credit card number and/or shipping address (FIGS. 11, 15 and 16) stored on file within the provider server, for example in a database store on a storage medium such as magnetic or optical discs. This process will be secured, and the card number that is displayed on the screen viewable to the participant will show a masked card number (1410 in FIG. 14). If the dollar amount corresponding to the available points is insufficient for the purchase (FIG. 12), the provider server initiates steps to let the user add to the available funds by using his or her personal credit card (FIG. 13).

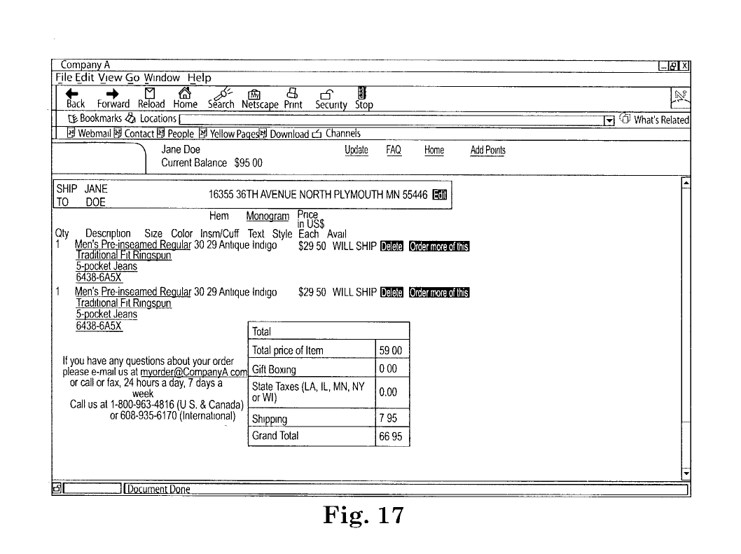

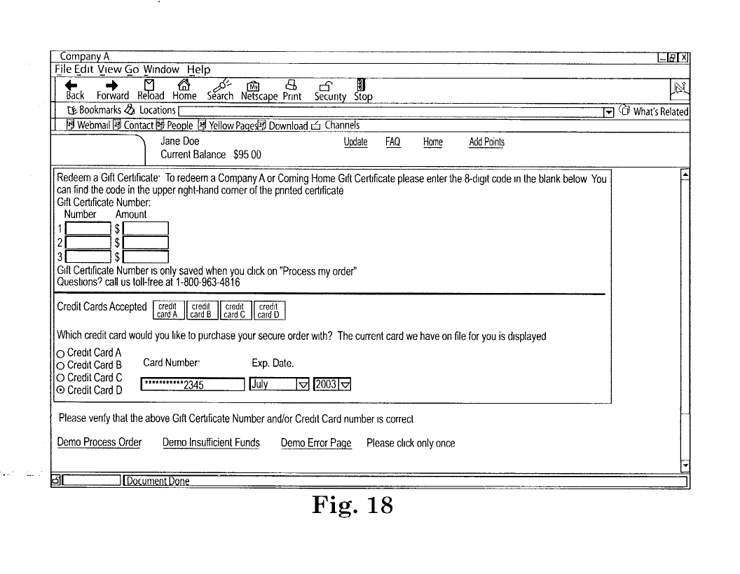

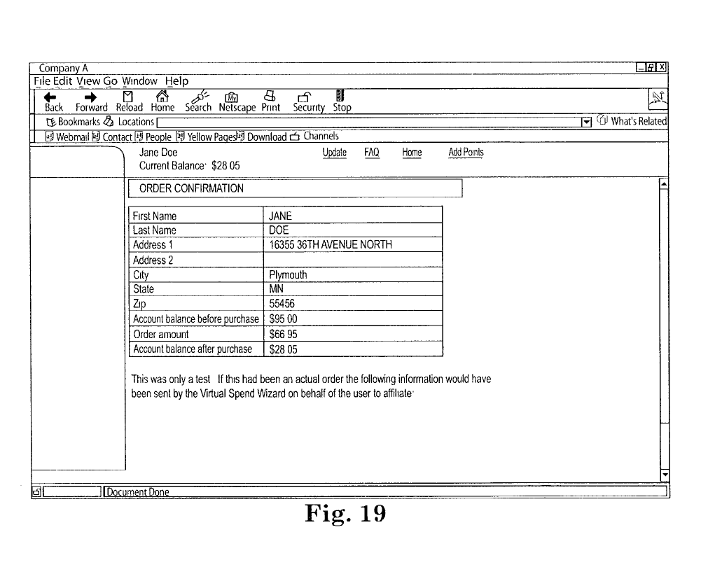

Whether personal funding is needed or not, once the available fund is sufficient for the purchase, the user is asked to review the purchase (FIG. 17) and confirm the purchase (FIG. 18). Once the purchase is confirmed, the finds required for the purchase are sent to the vendor from the credit card account by the credit card processor. The provider server then deducts the amount converted from the credit from the available credit amount and informs the user of the amount of the remaining credit (FIG. 19).

Thus, the invention allows implementation of on-line shopping programs with a high degree of flexibility on several levels: For a service provider and its sponsor clients, the provider can implement programs for multiple sponsors, each selecting a set of vendors to suit the sponsor's own interests instead of having to use a common set of vendors selected by the service provider. A sponsor can further refine its preference for different selected vendors by setting the monetary value of the credit according to vendor. A user can have a much wider selection of merchandise to choose from and, because the purchases are make directly at the vendors' web stores, there is opportunity to take advantage of any promotions or discounts offered by the vendors to the general public. The ability for users to supplement otherwise insufficient funds for purchases means that a user can use his or her credit at any time and does not have to wait until he or she has accumulated enough credit for a particular purchase. The conversion of credit amount to real currency amount also lets users have a real sense of the worth of the credit.

At the same time, the invention also offers security and control for sponsors to best suit their needs. The individualized payment accounts and the timing of funding those accounts reduce the likelihood of monetary loss due misappropriation of account numbers. Because a sponsor has control over which vendors the users can shop at with sponsor-provided credit, the sponsors can influence the users' purchases to be more consistent with the sponsor's goals and interests.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for implementing an on-line shopping program, the method comprising:
(a) allocating an amount of credit, in a predetermined unit, available to a user;
(b) providing the user with computer access to a copy of at least a portion of a first on-line document belonging to a first vendor and containing a description and pricing information of at least one item from the first vendor for the user to purchase;
(c) establishing a correspondence between the predetermined unit of credit and a unit of a currency in which the first vendor's item is priced;
(d) at least partially funding a payment account associated with the user with an amount corresponding to at least a portion of the allocated credit amount according to the correspondence established in step (c);
(e) after the user confirms a purchase including the first vendor's item, sending a sufficient payment from the payment account to the first vendor for the purchase; and
(f) deducting the amount of credit available to the user by the portion in step (d).

2. The method of claim 1, wherein step (b) comprises providing computer access via the Internet.

3. The method of claim 1, wherein step (d) comprises funding the payment account after the user confirms a purchase including the first vendor's item.

4. The method of claim 3, further comprising maintaining an amount of funds available from the payment account to below a predetermined level until the user confirms a purchase including the first vendor's item.

5. The method of claim 1, further comprising monitoring the on-line document of the first vendor for any change of a predetermined portion of the on-line document.

6. The method of claim 1, wherein step (d) further comprises permitting the user to at least partially fund the payment account from another source.

7. The method of claim 1, further comprising:
(bb) providing the user with computer access to a copy of at least a portion of a second on-line document belonging to a second vendor and containing a description and pricing information of at least one item from the second vendor for the user to purchase.
(cc) establishing a correspondence between the predetermined unit of credit and a unit of a currency in which the second vendor's item is priced;
(dd) at least partially funding a payment account associated with the user with an amount corresponding to at least a portion of the allocated credit amount according to the correspondence established in step (cc);
(ee) after the user confirms a purchase including the second vendor's item, sending a sufficient payment from the payment account to the second vendor for the purchase; and
(ff) deducting the amount of credit available to the user by the portion in step (dd).

8. The method of claim 7, wherein the correspondences established in steps (c) and (cc) are different from each other.

9. The method of claim 1, wherein step (a) comprises allocating an amount of credit based on an evaluation of the user's performance.

10. A method for implementing an on-line shopping program, the method comprising:
(a) allocating an amount of credit available to a user;
(b) selecting at least one predetermined vendor from whom the user is permitted to make purchases with the credit;
(c) providing the user with computer access to at least a portion of the contents of the vendor's on-line documents containing a description and pricing information of at least one item from the vendor;
(d) establishing a correspondence between a unit of the credit and a unit of a currency in which the vendor's item is priced if the two units are different from each other;
(e) at least partially funding a payment account associated with the user with an amount corresponding to at least a portion of the allocated credit amount according to any correspondence established in step (c);
(f) after the user confirms a purchase including the first vendor's item, sending a sufficient payment from the payment account to the vendor for the purchase; and
(g) deducting the amount of credit available to the user by the portion in step (d).

11. The method of claim 10, wherein step (c) comprises providing the user with computer access to a copy of at least a portion of the vendor's on-line documents.

12. A method of for implementing an on-line shopping program for a sponsor of the program, the method comprising:
(a) permitting the sponsor to select a plurality of vendors;
(b) allocating an amount of credit available to each of a plurality of users of the program; and
(c) for each vender and each user:
(i) providing the user with computer access to at least a portion of the vendors' on-line documents containing a description and pricing information of items sold by the vendor;
(ii) establishing a correspondence between a unit of the credit and a unit of a currency in which the vendor's item is priced if the two units are different from each other;
(iii) at least partially funding a payment account associated with the user with an amount corresponding to at least a portion of the allocated credit amount according to any correspondence established in step (ii);
(iv) after the user confirms a purchase including the first vendor's item, sending a sufficient payment from the payment account to the vendor for the purchase; and
(v) deducting the amount of credit available to the user by the portion in step (iii).

13. The method of claim 12, wherein step (c)(ii) includes establishing a conversion rate as the correspondence between a unit of the credit and a unit of a currency in which the vendor's item is priced.

14. The method of claim 13, wherein at least two conversion rates for two respective vendors are different from each other.
